(19) United States
(12) Patent Application Publication
(10) Pub. No.: US 2015/0144696 A1
(43) Pub. Date: May 28, 2015

(54) MAGNETIC TAG DEVICE, READER FOR A MAGNETIC TAG, AND METHOD OF INTERROGATING A MAGNETIC TAG

(71) Applicant: DEUTSCHE TELEKOM AG, Bonn (DE)

(72) Inventors: Mehran Roshandel, Berlin (DE); Hamed Ketabdar, Berlin (DE)

(21) Appl. No.: 14/412,690

(22) PCT Filed: Jul. 4, 2013
(86) PCT No.: PCT/EP2013/064134

§ 371 Date: Jan. 5, 2015

(30) Foreign Application Priority Data
Jul. 6, 2012 (EP) 12175325.5

(51) Int. Cl. G06K 19/06; G06K 7/08

(52) U.S. Cl. CPC G06K 19/06196; G06K 7/087
USPC 235/449; 235/493

(57) ABSTRACT

A magnetic tag device for generating a magnetic tag includes one or more magnetic field sources. The one or more magnetic field sources are configured to generate magnetic fields that superimpose so as to form an overall magnetic field exhibiting a predefined magnetic identification pattern representing the magnetic tag. The magnetic tag is readable by a computing device.

### CROSS-REFERENCE TO RELATED APPLICATIONS

This application is a U.S. National Phase application under 35 U.S.C. §371 of International Application No. PCT/EP2013064134, filed on Jul. 4, 2013, and claims benefit to European Patent Application No. EP 12175325.5, filed on Jul. 6, 2012. The International Application was published in English on Jan. 9, 2014, as WO 2014006136 A1 under PCT Article 21(2).

### FIELD

The invention is related to a magnetic tag device, a reader for a magnetic tag, and a method of interrogating a magnetic tag.

### BACKGROUND

In prior art, “radio-frequency identification tags” (RFID tags) are known. These devices are used, for example, for identification and/or localisation of objects such as goods in a store or for automotive vehicle identification.

For example, EP 1 770 592 A2 describes a method of interrogating a package bearing an RFID tag, and multiple items inside the package each bearing its own RFID tag, the RFID tag associated with the package including information about the RFID tags associated with the multiple items, comprising the steps of: (a) interrogating the RFID tag associated with the package to identify the package and the items in the package; (b) interrogating the RFID tags associated with the items in the package substantially simultaneously to identify the items; and (c) comparing the information obtained in steps (a) and (b) to verify the contents of the package.

An RFID tag typically comprises an antenna, an analogue circuit, digital circuit, and a storage. Further, it is distinguished between passive, active, and semi-active (or semi-passive) RFID tags. Passive RFID tags exclusively use the energy provided by the radio signal of an interrogator or reader in order to generate the responding signal as well as to supply power to the circuits; thus, they do not comprise an internal power supply. In contrast to this, both the energy for the response and the power supply of the circuits is provided by an energy source such as a small battery in active RFID tags. In semi-active responders, only the back scattering coefficients are controlled by means of the power supplied by the battery; the energy for the response is taken, however, from the radio signal of the interrogator.

In either case, it is a prerequisite that an electromagnetic field is generated by the interrogator or reader. According to the requirements regarding the range of the system, this leads to correspondent energy consumption. Also, the electromagnetic field can interfere with devices other than the RFID tag. There may be situations where interference is undesirable, for example, when other applications can be affected and perturbed. In another scenario, it may be essential to avoid the detection of the electromagnetic field of the interrogator. Therefore, there is a need for a tag device with which the described disadvantages can be avoided and method for using it.

### SUMMARY

In an embodiment, the invention provides a magnetic tag device for generating a magnetic tag, comprising: one or more magnetic field sources. The one or more magnetic field sources are configured to generate magnetic fields that superimpose so as to form an overall magnetic field exhibiting a predefined magnetic identification pattern representing the magnetic tag. The magnetic tag is readable by a computing device.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows an embodiment of the magnetic tag device according to the invention.

FIG. 2 shows another embodiment of the magnetic tag device according to the invention.

FIG. 3 shows still another embodiment of the magnetic tag device according to the invention.

### DETAILED DESCRIPTION

Embodiments of the present invention provide a magnetic tag device, a reader for a magnetic tag, and a method of interrogating a magnetic tag.

The expression “magnetic tag” (or in the following simply “tag”) shall refer here to any kind of magnetic field having a structure that can be used as an identification pattern. In particular, the pattern must be suitable for being identified by a correspondingly configured reading device (which is referred to as “reader” in the following). A device configured to generate a magnetic tag is denoted “magnetic tag device” throughout the following. Further, the expression “magnetic field” in the sense of this document is used as a generic term for both “magnetic induction” (sometimes also referred to as “magnetic field density” or “magnetic flux density”, in physics literature mostly denoted by the symbol B̅), and “magnetizing field” (sometimes also called “auxiliary magnetic field” or “magnetic field intensity”, in the literature mostly denoted by the symbol H̅).

In an embodiment, the invention provides a magnetic tag device for generating a magnetic tag, comprising one or more magnetic field sources, wherein the one or more magnetic field sources are arranged such that, upon generation of magnetic fields by the one or more magnetic field sources, their respective magnetic fields superimpose so as to form an overall magnetic field exhibiting a predefined pattern representing the magnetic tag.

Here, in order to allow for a general but simple formulation throughout the following, terms such as “superimposition” of magnetic fields or magnetic fields being “superimposed” denote that either the magnetic field is generated by two or more magnetic field sources or—if only one magnetic field source is involved—that the field is generated by only this single magnetic field source.

The magnetic tag device may comprise magnetisable materials, for example iron, nickel and/or cobalt, configured to manipulate the form of the overall magnetic field.

Preferably, each of the magnetic field sources of the magnetic tag according to the invention comprises at least one permanent magnet.

According to one embodiment of the magnetic tag device according to the invention, at least one of the magnetic field sources comprises at least one controllable magnet; and wherein each of the remaining magnetic field sources comprises at least one permanent magnet.

In one preferred embodiment of the invention, each of the controllable magnets comprises at least one means for moving electrical charges, preferably a conducting medium, for example a wire lead and/or an induction coil.

The magnetic tag device may comprise a controller configured for controlling the controllable magnets, for example a microcontroller or a computer. The controller may be configured to control the controllable magnets such that a variety of different magnetic tags can be generated. The controller may be configured to control the controllable magnets such that a magnetic tag exhibits a predefined pattern along the time-axis.

According to a preferred embodiment of the invention, the magnetic field sources are bar magnets. The bar magnets can be, for example, permanent bar magnets or electromagnets having a coil wound along straight line.

In one embodiment of the invention, the magnetic field sources are arranged on the angles of a virtual regular polygon.

Preferably, the magnetic field sources are arranged such that the magnetic moment of each of the magnetic field sources is oriented

a) towards the center point of the virtual regular polygon or
b) away from the center point of the virtual regular polygon.

One embodiment of the invention relates to a magnetic tag device, wherein the virtual regular polygon has an odd number of angles and the orientation of the magnetic moments of any two neighbored magnetic field sources is alternating towards and away from the center point of the virtual regular polygon.

Here, the term “two neighboured magnetic field sources” shall denote that the two magnetic field sources—or more precisely: the centre of gravity or the geometric centre of each of the magnetic field sources—are positioned on neighboured angles of the virtual regular polygon.

According to a preferred embodiment of the magnetic tag device of the invention, the magnetic field sources are arranged such that with respect to one of the magnetic field sources, each of the other magnetic field sources is oriented either parallel or antiparallel.

The magnetic field sources may be arranged such that the orientation of the magnetic moments of all magnetic field sources is parallel.

In an alternative embodiment of the magnetic tag device, the virtual regular polygon has an odd number of angles and the orientation of the magnetic moments of any two neighbored magnetic field sources is antiparallel.

In one preferred embodiment of the invention, the magnetic field sources are arranged as a planar matrix, for example at the grid points of a virtual regular matrix, and wherein preferably the magnetic moments of the magnetic field sources are all oriented in parallel or antiparallel.

A “matrix” shall refer here to a set of positions within a rectangular arrangement having a width in a horizontal direction and a height in a vertical direction, the arrangement being subdivided into a number of sections along both the horizontal and the vertical direction, and wherein said set of positions comprises all intersection points of the edges of the sections along the horizontal direction with the edges of the sections along the vertical direction. Moreover, a “regular matrix” refers to a matrix in the above sense, wherein the arrangement is subdivided into a number of equally sized sections along both the horizontal and the vertical direction.

Another aspect of the invention relates to a reader for a magnetic tag generated by a magnetic tag device according to the invention, wherein the reader comprises at least one magnetic sensor, preferably two magnetic sensors, configured to measure an overall magnetic field generated by the magnetic tag device.

The at least one magnetic sensor may comprise a magnetic needle and/or a hall effect sensor.

One preferred embodiment of the invention relates to a reader, wherein the reader comprises an evaluation unit, for example a microcontroller or a microchip, configured:

a) to generate a numeric representation of the measured magnetic field; and
b) to compare the numeric representation of the measured magnetic field with numerical representations of a number of predefined patterns of magnetic fields.

A numerical representation of a magnetic field can be, e.g., a sample, wherein for each of a number of points sampling the 3-dimensional space around the magnetic tag (defined, e.g., by a virtual box or a virtual sphere around the magnetic tag), a magnetic field vector (or a component or the norm thereof) is assigned. However, it might be sufficient that for each of a number of points sampling a 2-dimensional space in the vicinity of the magnetic tag, a magnetic field vector (or a component or the norm thereof) is assigned. Then, two numerical representations of a magnetic field can be easily compared by comparing the magnetic field vector (or a component or the norm thereof) for each of the sample points. Therein, interpolation methods and/or affine transformations can also be employed. This way, a numerical representation of a measured magnetic field can be easily compared to a predefined numerical representation that is preferably stored in the reader. In particular, the tolerance of the reader can be adjusted by choosing a maximum value up to which the deviation between (the considered components of) two vectors or the norm of two vectors to be compared are allowed to deviate.

As usual, only a restricted number of magnetic sensors will be used in the reader, for example one or two sensors, and a sample is generated by moving the reader—and thereby the sensor(s)—through the magnetic field, so that measurements of the field can be taken at different positions.

The reader is preferably a mobile phone or a smart phone or a portable computer, for example a tablet computer.

A further aspect of the invention relates to a method of interrogating a magnetic tag generated by a magnetic tag device according to the invention, with the steps:

a) measuring a magnetic tag;
b) generating a numeric representation of the magnetic tag measured in step a);
c) comparing the numeric representation of the magnetic tag generated in step b) with numerical representations of a number of predefined patterns of magnetic fields.

Step a) of measuring a magnetic tag may comprise moving a magnetic sensor, for example a magnetic needle or a hall effect sensor, within the magnetic field representing the magnetic tag.

Alternatively, step a) of measuring a magnetic tag comprises measuring the magnetic field at a plurality of positions at time by means of two, or three, or more magnetic sensors, for example magnetic needles and/or a hall effect sensors.

Preferably, steps a) to c) are performed by means of the reader according to the invention as described above.

A magnetic tag device according to the invention can be used to control a device in the vicinity of the tag. For example, the tag can be arranged on, at, or under a desk or table in a hidden manner. Further, a mobile phone or smartphone can be configured as a reader. Then, a certain action can be activated when the phone is brought in the vicinity of the magnetic tag. For example, during a meeting the phone can be laid onto the table within the tag's area of influence in order to switch off loud ringing in case of a phone call. Another possible action is making an emergency call without attracting attention, for example at a cashier's desk in a bank.

If the magnetic tag device itself is externally controllable—for example, if the device comprises at least one electromagnet—actions of the phone can also be externally triggered. In particular, this allows for transmission of information via the tag. For example, when the tag is connected with a “smart” refrigerator being able to count its contents, this information can be processed and be represented by a controllable tag. In other words, the tag generated by the tag device is dependent on the “state” of the contents in the refrigerator. The tag can then be read by the reader that again might be integrated in a mobile phone or smartphone. Eventually, a purchase list can automatically be created by the information represented by the tag.

When using controllable magnets within the magnetic tag device—i.e. magnets with the magnetic field of which being (externally) controllable, for example, an electromagnet—it is also possible to increase the complexity of the magnetic tag by enhancing it by the time-axis. In other words, the pattern of the magnetic field constituting the tag is varied with the time.

It will be appreciated that a wide variety of further actions are also possible with the magnetic tag according to the invention and, preferably, a reader therefor.

Other aspects, features, and advantages will be apparent from the summary above, as well as from the description that follows, including the figures and the claims.

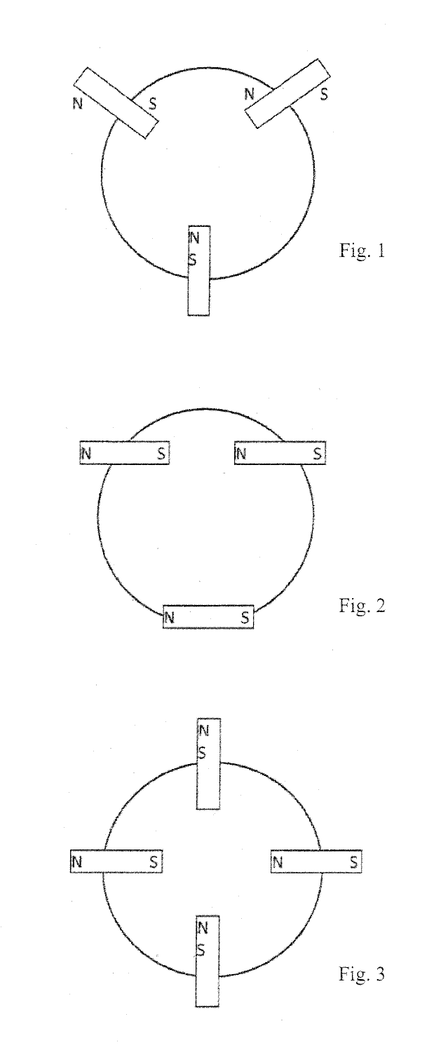

FIGS. 1 and 2 show embodiments of the magnetic tag device according to the invention, wherein three bar magnets are arranged on a (virtual) circle, each of the magnets thereby having the same distance to both of its neighboured magnets. In other words, the magnets or more precisely: the geometric centers of which are arranged on the angles of an equilateral triangle. The bar magnets are preferably permanent magnets or electromagnets.

In FIG. 1, the three bar magnets are arranged the following way: the magnetic moment of two of the magnets is oriented such that the north pole is directed towards the centre of the circle, the magnetic moment of the remaining third magnet, however, is oriented such that the south pole is directed towards the centre of the circle. Of course, other similar embodiments can be easily derived by modifying the embodiment of FIG. 1 in that the orientation of all magnets is chosen such that the north pole (or the south pole) is directed towards the centre of the circle.

In FIG. 2, however, the bar magnets are arranged such that all of the respective magnetic moments are oriented in parallel to each other. A similar embodiment can be derived from this embodiment by altering it such that the orientation of one of the three bar magnet is inverted.

FIG. 3 shows an embodiment of the magnetic tag device according to the invention, wherein four bar magnets are arranged on a (virtual) circle, each of the magnets thereby having the same distance to both of its (on the line of the circle directly) neighboured magnets. In other words, the magnets—or more precisely: the geometric centers of which—are arranged on the angles of square. The bar magnets are preferably permanent magnets or electromagnets. Moreover, two neighboured magnets are oriented such that the north pole is directed towards the centre of the circle, the remaining two magnets are oriented such that the south pole is directed towards the centre of the circle.

Modifications from FIG. 3 can be easily derived: For example, in a further embodiment, the north pole of all of the four magnets is directed towards the centre of the circle. In another alteration, the south pole of all of the four magnets is directed towards the centre of the circle. In yet another embodiment, the magnetic moment of any two neighboured are alternating. In the latter case, the north pole of two of the magnets is directed towards the centre of the circle, and the south pole of the other two magnets is directed towards the centre of the circle.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

Furthermore, in the claims the word “comprising” does not exclude other elements or steps, and the indefinite article “a” or “an” does not exclude a plurality. A single unit may fulfil the functions of several features recited in the claims. The terms “essentially”, “about”, “approximately” and the like in connection with an attribute or a value particularly also define exactly the attribute or exactly the value, respectively. Any reference signs in the claims should not be construed as limiting the scope.

1. A magnetic tag device for generating a magnetic tag, comprising:
one or more magnetic field sources, wherein the one or more magnetic field sources are configured to generate magnetic fields that superimpose so as to form an overall magnetic field exhibiting a predefined magnetic identification pattern representing the magnetic tag, the magnetic tag being readable by a computing device.

2. The magnetic tag device according to claim 1, wherein the one or more magnetic field sources comprise magnetisable materials, configured to manipulate the form of the overall magnetic field.

3. The magnetic tag device according to claim 1, wherein each of the one or more magnetic field sources comprises at least one permanent magnet.

4. The magnetic tag device according to claim 1, wherein at least one of the one or more magnetic field sources comprises at least one controllable magnet; and wherein each of the remaining magnetic field sources comprises at least one permanent magnet.

5. The magnetic tag device according to claim 4, wherein each of the controllable magnets comprises conducting medium.

6. The magnetic tag device according to claim 5, wherein the conducting medium is a wire lead and/or an induction coil.

7. The magnetic tag device according to claims 4, further comprising:
a controller, configured to control the controllable magnets.

8. The magnetic tag device according to claim 7, wherein the controller is a microcontroller or a computer.

9. The magnetic tag device according to claim 7, wherein the controller is configured to control the controllable magnets such that a variety of different magnetic tags can be generated.

10. The magnetic tag device according to claim 7, wherein the controller is configured to control the controllable magnets such that the magnetic tag exhibits a predefined pattern along the time-axis.

11. The magnetic tag device according to claim 1, wherein the one or more magnetic field sources are bar magnets.

12. The magnetic tag device according to claim 1, wherein the one or more magnetic field sources are arranged at angles of a virtual regular polygon.

13. The magnetic tag device according to claim 12, wherein the one or more magnetic field sources are arranged such that the magnetic moment of each of the magnetic field sources is oriented
a) towards the center point of the virtual regular polygon or
b) away from the center point of the virtual regular polygon.

14. The magnetic tag device according to claim 13, wherein the virtual regular polygon has an odd number of angles and the orientation of the magnetic moments of two neighbored magnetic field sources is alternating towards and away from the center point of the virtual regular polygon.

15. The magnetic tag device according to claim 12, wherein the one or more magnetic field sources are arranged such that with respect to one of the magnetic field source, each of the other magnetic field sources is oriented either parallel or antiparallel.

16. The magnetic tag device according to claim 15, wherein the one or more magnetic field sources are arranged such that the orientation of the magnetic moments of all the magnetic field sources is parallel.

17. The magnetic tag device according to claim 15, wherein the virtual regular polygon has an odd number of angles and the orientation of the magnetic moments of two neighbored magnetic field sources is antiparallel.

18. The magnetic tag device according to claim 1, wherein the one or more magnetic field sources are arranged as a planar matrix.

19. A reader configured for reading the magnetic tag generated by the magnetic tag device according to claim 1, wherein the reader comprises:
at least one magnetic sensor, configured to measure the overall magnetic field generated by the magnetic tag device,
wherein the reader is a computing device.

20. The reader according to claim 19, wherein the at least one magnetic sensor comprises a magnetic needle.

21. The reader according to claim 19, wherein the at least one magnetic sensor comprises a hall effect sensor.

22. The reader according to claim 19, wherein the reader comprises an evaluation unit, configured to:
a) generate a numeric representation of the measured magnetic field; and
b) compare the numeric representation of the measured magnetic field with numerical representations of a number of predefined patterns of magnetic fields.

23. The reader according to claim 22, wherein the evaluation unit is a microcontroller or a microchip.

24. A method of interrogating the magnetic tag generated by the magnetic tag device according to claim 1, comprising:
measuring, by a computing device, the magnetic tag;
generating, by the computing device, a numeric representation of the measured magnetic tag;
comparing, by the computing device, the numeric representation with numerical representations of a number of predefined patterns of magnetic fields.

25. The method according to claim 24, wherein measuring the magnetic tag comprises moving a magnetic sensor within the magnetic field representing the magnetic tag.

26. The method according to claim 25, wherein the magnetic sensor is a magnetic needle or a hall effect sensor.

27. The method according to claim 24, wherein measuring the magnetic tag comprises measuring the magnetic field at a plurality of positions at time using two or more magnetic sensor.

28. (canceled)

29. The method according to claim 1, wherein the computing device is at least one of a mobile phone, a smart phone, a portable computer or a tablet computer.
